(19) United States
(12) Patent Application Publication
(10) Pub. No.: US 2023/0418681 A1
(43) Pub. Date: Dec. 28, 2023

(54) INTELLIGENT LAYER DERIVED DEPLOYMENT OF CONTAINERS

(71) Applicant: Red Hat, Inc., Raleigh, NC (US)

(72) Inventors: Stephen Coady, Waterford (IE); Leigh Griffin, Waterford (IE)

(21) Appl. No.: 17/850,900

(22) Filed: Jun. 27, 2022

(51) Int. Cl. G06F 9/50

(52) U.S. Cl. CPC G06F 9/5077; G06F 9/5011; G06F 9/5072

(57) ABSTRACT

Systems and methods for intelligently scheduling containers are described. A set of different layers that is locally available on each of a set of compute nodes may be determined. In response to receiving a request to deploy a container, a specification file of the container may be decomposed to determine a set of layers required for execution of the container. The set of required layers may be compared to the set of different layers that is locally available on each of the set of compute nodes to determine which of the set of compute nodes has a largest number of the set of required layers locally available. The container may be assigned to one of the set of compute nodes based on a number of required layers locally available on each of the set of compute nodes and resource information of each of the set of compute nodes.

### TECHNICAL FIELD

Aspects of the present disclosure relate to container-orchestration systems, and more particularly, to intelligently scheduling containers in a container-orchestration system.

### BACKGROUND

A container orchestration engine (such as the Redhat™ OpenShift™ platform) may be a platform for developing and running containerized applications and may allow applications and the data centers that support them to expand from just a few machines and applications to thousands of machines that serve millions of clients. Container orchestration engines comprise a control plane and a cluster of compute nodes on which pods may be scheduled. A pod may refer to one or more containers deployed together on a single host, and is the smallest compute unit that can be defined, deployed, and managed by the control plane. The control plane may include a scheduler that is responsible for scheduling new pods onto compute nodes within the cluster.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2A is a block diagram that illustrates an example system for intelligently scheduling containers, in accordance with some embodiments of the present disclosure.

FIG. 2B is a block diagram that illustrates an example system for intelligently scheduling containers, in accordance with some embodiments of the present disclosure.

FIG. 2C is a block diagram that illustrates an example process for determining what layers are locally available on a compute node, in accordance with some embodiments of the present disclosure.

FIG. 3 is a block diagram that illustrates a process of determining a compute node that has the largest number of layers required to run a container locally available, in accordance with some embodiments of the present disclosure.

FIG. 4 is a flow diagram of a method for intelligently scheduling containers, in accordance with some embodiments of the present disclosure.

FIG. 5 is a block diagram of an example computing device that may perform one or more of the operations described herein, in accordance with some embodiments of the present disclosure.

### DETAILED DESCRIPTION

Large, container-heavy architectures may be implemented using multiple compute nodes for resiliency, where many containers (or pods) may run on each compute node. One such example involves serverless functions, which can scale to large numbers and instances of serverless functions.

When scheduling containers to compute nodes, a scheduler/load balancer of the container orchestration engine may deploy containers to compute nodes in a round-robin or random fashion. However, such approaches to scheduling containers result in a large amount of wasted resources, especially when scheduling containers in a large, container-heavy architecture. This is because upon receiving the container specification (i.e., instructions for executing the container), the destination compute node must pull down (e.g., from an image repository) and store the required layers to enable the container to function. Such layer retrieval has considerable network and storage costs associated with it, and thus when compute nodes that do not already have a large number of the required layers are assigned a container, they must expend significant network and storage resources to obtain the required layers that they do not have. Because of the random or round-robin nature of traditional schedulers, containers are not often assigned to compute nodes that already have a significant number of the required layers.

The present disclosure addresses the above-noted and other deficiencies determining a set of different layers that is locally available on each of a set of compute nodes of a container orchestration platform. The set of different layers locally available on a compute node may be determined by an agent executing on the compute node. In response to receiving a request to deploy a container, a master agent executing on a control plane of the container orchestration platform may decompose a specification file of the container to determine a set of layers required for execution of the container. The master agent may compare the set of required layers to the set of different layers that is locally available on each of the set of compute nodes to determine which of the set of compute nodes has the largest number of the set of required layers locally available. The container may be assigned to one of the set of compute nodes based on a number of required layers locally available on each of the compute nodes and resource information of each of the set of compute nodes.

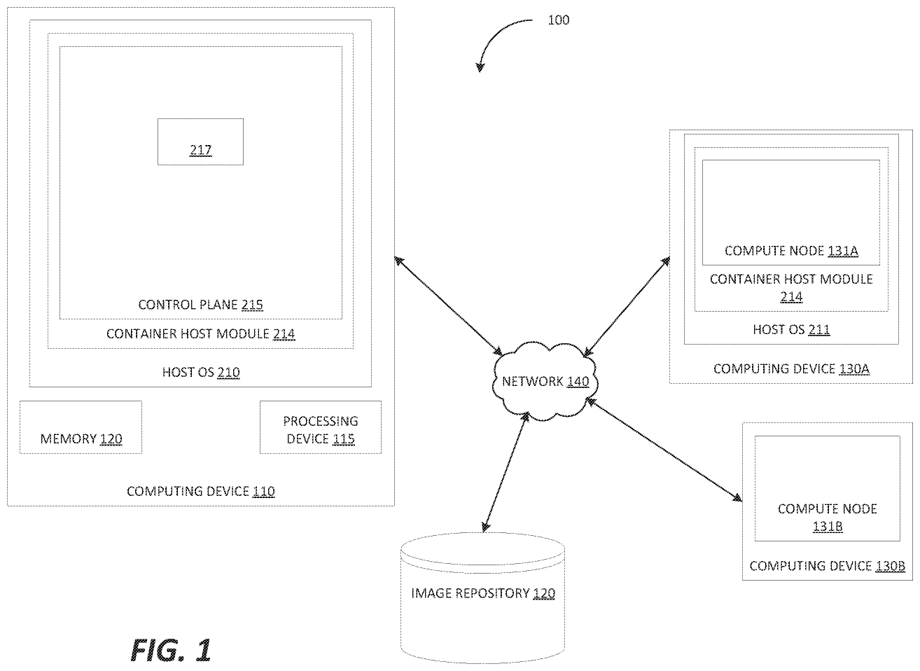

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g. cell towers), etc. In some embodiments, the network 140 may be an L3 network. The network 140 may carry communications (e.g., data, message, packets, frames, etc.) between computing device 110 and computing devices 130. Each computing device may include hardware such as processing device 115 (e.g., processors, central processing units (CPUs), memory 120 (e.g., random access memory 120 (e.g., RAM), storage devices (e.g., hard-disk drive (HDD), solid-state drive (SSD), etc.), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110.

Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 of computing device 110 and 130A respectively, as discussed in more detail below. The host OS of a computing device 110 and 130 may manage the execution of other components (e.g., software, applications, etc.) and/or may manage access to the hardware (e.g., processors, memory, storage devices etc.) of the computing device. In some embodiments, computing device 110 may implement a control plane (e.g., as part of a container orchestration engine) while computing devices 130 may each implement a compute node (e.g., as part of the container orchestration engine).

In some embodiments, a container orchestration engine 214 (referred to herein as container host 214), such as the Redhat™ OpenShift™ module, may execute on the host OS 210 of computing device 110 and the host OS 211 of computing device 130A, as discussed in further detail herein. The container host module 214 may be a platform for developing and running containerized applications and may allow applications and the data centers that support them to expand from just a few machines and applications to thousands of machines that serve millions of clients. Container host 214 may provide an image-based deployment module for creating containers and may store one or more image files for creating container instances. Many application instances can be running in containers on a single host without visibility into each other's processes, files, network, and so on. In some embodiments, each container may provide a single function (often called a “micro-service”) or component of an application, such as a web server or a database, though containers can be used for arbitrary workloads. In this way, the container host 214 provides a function-based architecture of smaller, decoupled units that work together.

An image file may be stored by the container host 214 or an image repository 120. The image repository 120 may be e.g., a registry server that may store image files (e.g., docker images), as discussed in further detail herein. In some embodiments, the image file may include one or more base layers. An image file may be shared by multiple containers. When the container host 214 creates a new container, it may schedule the container to a compute node 131 which may retrieve the image file for the container (or any base layers required to complete the image file) e.g., from the image repository 120. The container host 214 may then add a new writable (e.g., in-memory) layer on top of the underlying base layers. However, the underlying image file remains unchanged. Base layers may define the runtime environment as well as the packages and utilities necessary for a containerized application to run. Thus, the base layers of an image file may each comprise static snapshots of the container's configuration and may be read-only layers that are never modified. Any changes (e.g., data to be written by the application running on the container) may be implemented in subsequent (upper) layers such as in-memory layer. Changes made in the in-memory layer may be saved by creating a new layered image.

Container host 214 may include a storage driver (not shown), such as OverlayFS, to manage the contents of an image file including the read only and writable layers of the image file. The storage driver may be a type of union file system which allows a developer to overlay one file system on top of another. Changes may be recorded in the upper file system, while the lower file system (base image) remains unmodified. In this way, multiple containers may share a file-system image where the base image is read-only media.

By their nature, containerized applications are separated from the operating systems where they run and, by extension, their users. The control plane 215 may expose applications to internal and external networks by defining network policies that control communication with containerized applications (e.g., incoming HTTP or HTTPS requests for services inside the cluster 132).

A typical deployment of the container host 214 may include a control plane 215 and a cluster of compute nodes 131, including compute nodes 131A and 131B (also referred to as compute machines). The compute nodes 131 may run the aspects of the container host 214 that are needed to launch and manage containers, pods, and other objects. For example, a worker node may be a physical server that provides the processing capabilities required for running containers in the environment. A worker node may also be implemented as a virtual server, logical container, or GPU, for example.

While the image file is the basic unit containers may be deployed from, the basic units that the container host 214 may work with are called pods. A pod may refer to one or more containers deployed together on a single host, and is the smallest compute unit that can be defined, deployed, and managed. There are numerous different scenarios when a new pod must be created. For example, a serverless function may need to scale or a new application may need to be deployed. The control plane 215 may also run a scheduler service 217 that is responsible for determining placement of (i.e., scheduling) new pods onto compute nodes 131 within the cluster 132. Although current scheduler services may perform scheduling of container/pod assignments in e.g., a random or round robin fashion, embodiments of the present disclosure provide techniques for scheduling container/pod assignments in a more resource efficient manner that also allows for faster deployment of containers, as described in further detail herein.

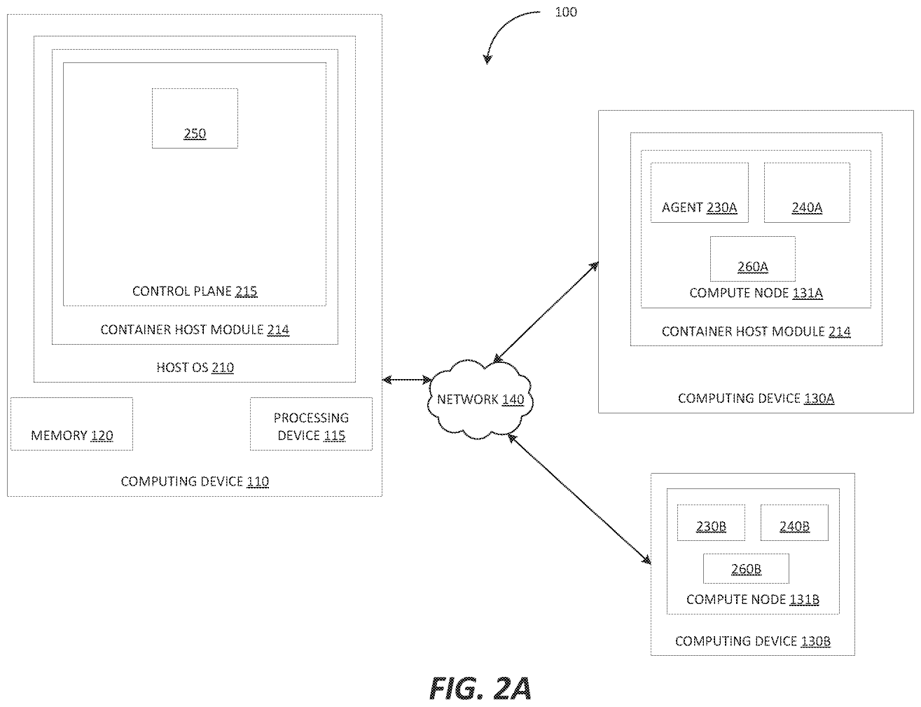

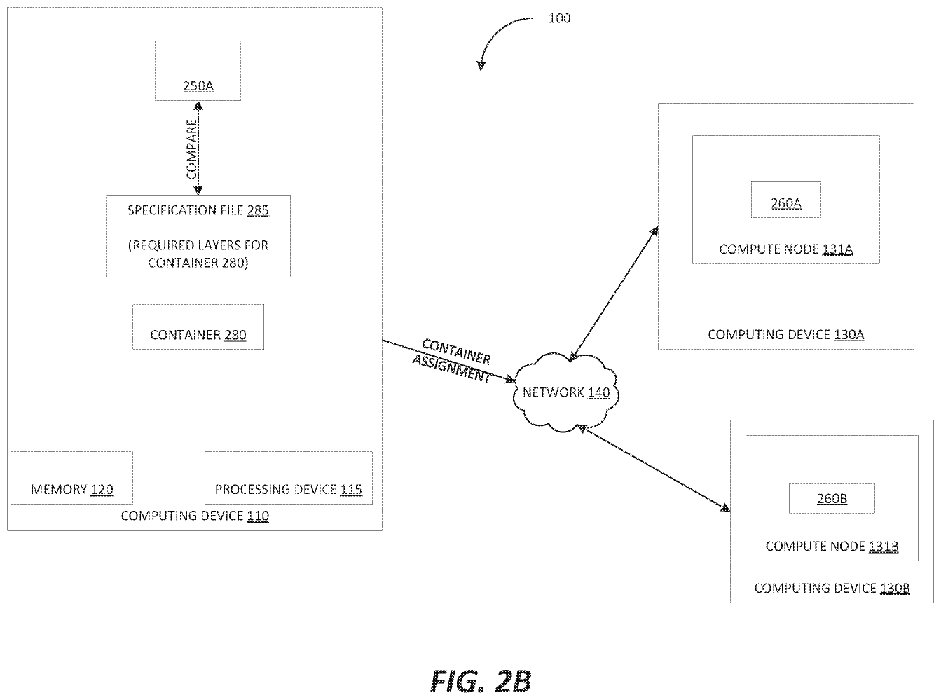

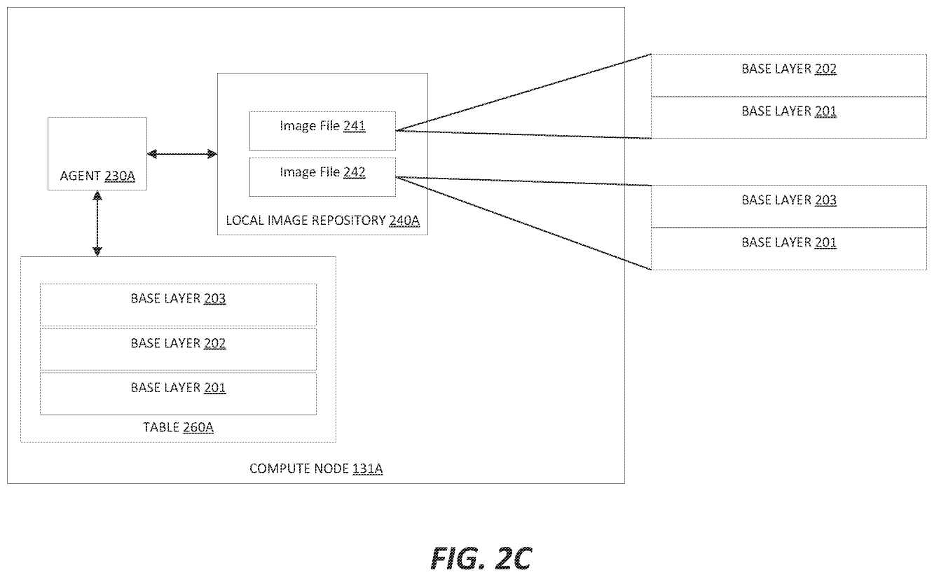

FIGS. 2A and 2B illustrate the system 100 in accordance with some embodiments of the present disclosure. Each compute node 131 may include its own local image repository 240 where image files that have been imported by the compute node 131 (e.g., from the image repository 120) may be stored. Each compute node 131 may also include an agent 230 which may communicate with the corresponding local image repository 240 in order to maintain a table 260 of all of the layers (e.g., base layers) that are stored on the compute node 131, as discussed further with respect to FIG. 2B. The control plane 215 include a master agent 250 that will perform the function of scheduling containers as discussed in further detail herein. The master agent 250 may communicate with the respective agent 230 of each compute node 131 in order to obtain that compute node 131's table 260 and gain insight as to the distribution and availability of layers among the compute nodes 131. Stated differently, the master agent 250 may communicate with the respective agent 230 of each compute node 131 to determine a set of different layers that are locally available on that worker node 131. The master agent 250 may maintain a master table 250A that indicates the set of different layers available on each of the compute nodes 131.

FIG. 2C illustrates an agent 230A determining the layers that are stored on the compute node 131A. The agent 230A may communicate with the local image repository 240A to determine the different image files that are locally available to the compute node 131A. In the example of FIG. 2C, the agent 230A may determine that image files 241 and 242 are locally available to the compute node 131A. The agent 230A may then decompose each of the image files 241 and 242 to determine the layers they are comprised of, and determine that image file 241 comprises layers 201 and 202 and that image file 242 comprises layers 201 and 203. Each of the layers 201 and 202 may have an associated hash and the agent 230A may determine the number of unique hashes in order to determine the number of different layers that are locally available to the compute node 131A. In the example of FIG. 2C, the hash for layers 202 and 203 may each show up once, while the hash for layer 201 may show up twice. Thus, the agent 230A may determine that there are three unique hashes, corresponding to layers 201, 202, and 203 respectively. The agent 230A may update table 260A to indicate that layers 201, 202, and 203 are locally available to the compute node 131A.

As the compute node 131A imports additional image files or layers, or deletes certain image files or layers, the agent 230A may perform the process described above with respect to FIG. 2B (e.g., at regular intervals or in response to import or deletion of image files or layers) in order to determine the layers that are currently locally available to the compute node 131A and update the table 260A.

Referring back to FIGS. 2A and 2B, the master agent 250 may monitor the container host 214's deployment queue and when a new container is queued for deployment into the environment, the master agent 250 may request the container's specification file 285. The master agent 250 may decompose the container's specification file 285 into layers required for execution of the container and cross reference the layers required for execution of the container with the table 250A in order to identify which compute node(s) 131 already store the most layers required for execution of the container (i.e., layers that appear within the specification file 285 of the container). The master agent 250 may determine the appropriate compute node 131 on which to deploy the container based on a number layers required for execution of the container that is locally available on each of the compute nodes 131 as well as on the available resources of each compute node 131. In some embodiments, the master agent 250 may determine which compute nodes 131 have the most layers required for execution of the container (e.g., the top 3, 5 or any other appropriate number), and consider only those compute nodes 131 when making scheduling decisions about the container to an appropriate node 131. The available resources of each compute node 131 may include the available network bandwidth, the available CPU resources, and the available memory resources (e.g., available storage), among others.

The goal of the master agent 250 is to find a compute node 131 where deploying the container will minimize the footprint impact with respect to network overhead, CPU availability, and available storage. The more layers required for execution of the container 280 that are locally available on a particular compute node 131, the fewer layers required for execution of container 280 the particular container 131 will have to pull (thus saving network bandwidth). Thus, the master agent 250 may balance the number of layers that potential compute nodes 131 may have to pull (e.g., from image repository 120) to obtain all of the layers required for execution of the container with available CPU/storage resources to accommodate the additional layers pulled when determining a compute node 131 to assign the container to. Upon determining the compute node 131 that the container should be assigned to, the master agent 250 may instruct the control plane 215 to send the container to the determined compute node 131.

As the architecture of the system 100 increases in size, the advantages of the embodiments of the present disclosure increase as well since many image files can comprise hundreds of layers, many of which are statistically likely to already be present in unrelated images that are currently stored on compute nodes 131. This provides a large benefit in terms of resource conservation compared to current solutions to container scheduling and has the added benefit of speeding up the bring-up time of a container by virtue of utilizing a larger number of locally stored layers.

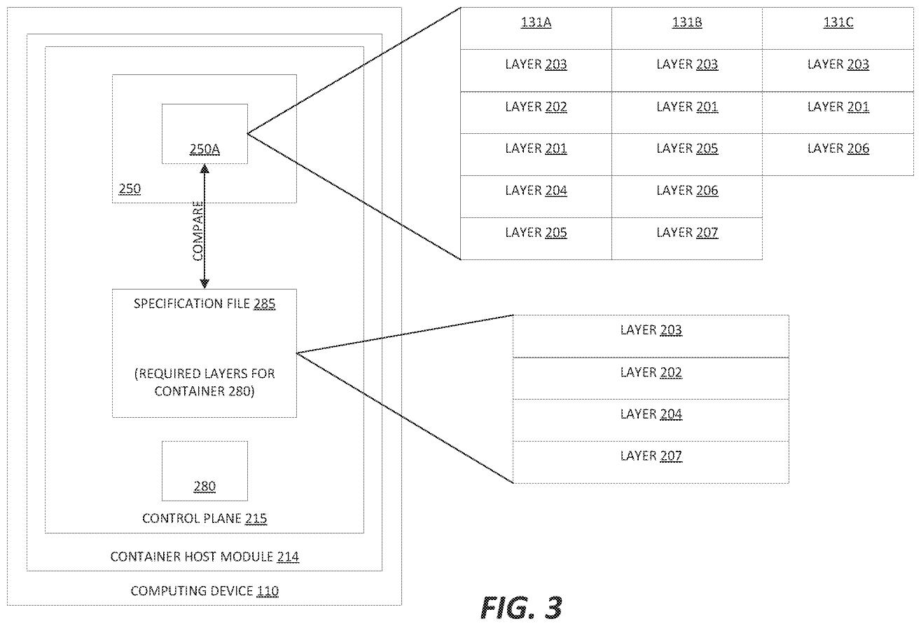

FIG. 3 illustrates the computing device 110 implementing an example process of scheduling of a container 280, in accordance with some embodiments of the present disclosure. The master agent 250 may query the agent 230 of each of the compute nodes 131 to determine the set of different layers that is locally available on each of the compute nodes 131. The master agent 250 may then compile this information into table 250A. As shown in FIG. 3, the compute node 131A may include layers 201, 202, 203, 204, and 205. The compute node 131B may include layers 201, 203, 205, 206, and 207. The compute node 131C may include layers 201, 203, and 206. Upon receiving a request to create container 280, the master agent 250 may analyze the specification file 285 of the container 280 to determine the set of layers required for execution of the container 280. In the example of FIG. 3, the set of layers required for execution of the container 280 may include layers 201, 203, 204, and 207. The master agent 250 may cross reference the set of layers required for execution of the container 280 with the table 250A in order to determine the number of the set of layers required for execution of the container 280 that are locally available on each compute node 131. The master agent 250 may determine a compute node 131 to assign the container 280 to based on the number of the set of layers required for execution of the container 280 that are locally available on each compute node 131 and resource availability information of each of the compute nodes 131. The resource availability information of a compute node 131 may include the network bandwidth of the compute node 131, a CPU availability of the compute node 131, and a memory availability (i.e., available storage) of the compute node 131.

In one example illustrated by FIG. 3, the master agent 250 may determine that compute node 131A has the largest number of the set of layers required for execution of the container 280 (i.e., 3 out of 4 of the layers required for execution of the container 280) and that the compute node 131A has sufficient network bandwidth to pull layer 207 and sufficient storage to store layer 207. The master agent 250 may thus determine that the container 280 should be assigned to compute node 131A.

In another example illustrated by FIG. 3, the master agent 250 may determine that although compute node 131A has the largest number of the set of layers required for execution of the container 280, it does not have sufficient bandwidth and/or storage to pull and/or store layer 207 (or that pulling and/or storing layer 207 would utilize all of its remaining bandwidth and storage). The master agent 250 may also determine that compute node 131B (which has layers 203 and 207) has one less required layer than compute node 131A, but has considerably more network bandwidth and storage than compute node 131A, such that pulling and storing layers 202 and 204 would still leave compute node 131B with a significant amount of storage and network bandwidth. Thus, when scheduling a container, the master agent 250A may determine that the container 280 should be assigned to compute node 131B. As can be seen, the master agent 250 may balance considerations of the number of the set of layers required for execution of the container 280 that are locally available on each compute node 131 with resource availability information such as available network bandwidth and available storage.

In some embodiments, the master agent 250 may perform a load balancing function that includes monitoring the cluster of compute nodes 131 to determine whether/when a container should be migrated from one compute node 131 to another and intelligently determining which compute node 131 the container should be migrated to. Referring back to FIG. 2A, upon determining that the particular container (not shown) executing on compute node 131A needs to be migrated, the master agent 250 may decompose the particular container's specification file (not shown) into the layers required for execution of the particular container and cross reference the layers required for execution of the particular container with the table 250A in order to identify a number layers required for execution of the particular container (i.e., layers that appear within the specification file of the particular container) that is locally available on each of the compute nodes 131. As discussed hereinabove, each agent 230 may perform the process described above with respect to FIG. 2B at regular intervals or on any other appropriate basis, thus allowing the master agent 250 to keep the table 250A up to date (e.g., by communicating with each agent 230 on any appropriate basis). The master agent 250 may determine the appropriate compute node 131 to which the particular container should be migrated based on a number layers required for execution of the particular container that is locally available on each of the compute nodes 131 as well as on the available resources of each compute node 131.

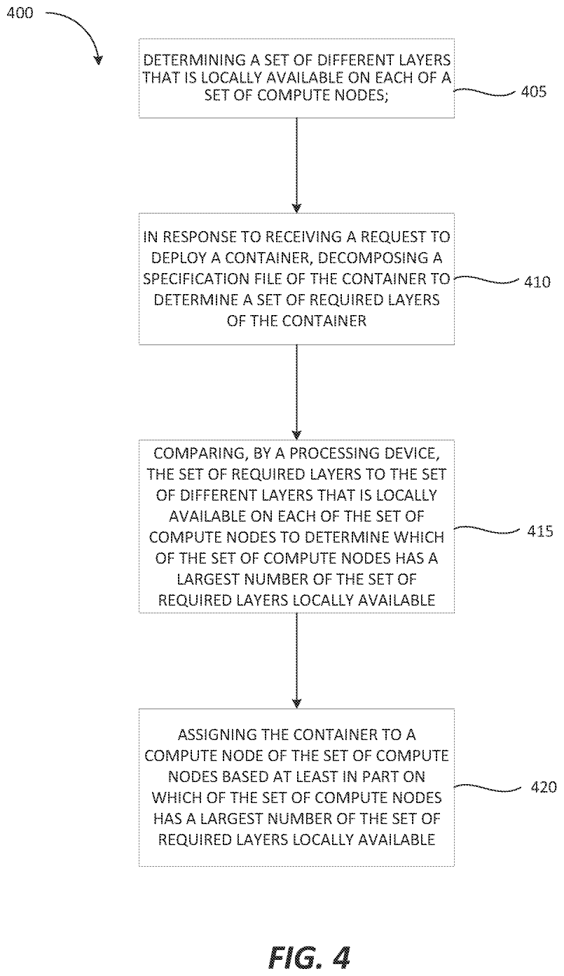

FIG. 4 is a flow diagram of a method 400 for intelligently scheduling containers, in accordance with some embodiments of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing devices 110 and 130 illustrated in FIGS. 1, 2A, and 2B).

Referring simultaneously to FIGS. 2A and 2B, at block 405, the computing device 110 may determine a set of different layers that is locally available on each of the compute nodes 131. More specifically, each compute node 131 may include its own local image repository 240 where image files that have been imported by the compute node 131 (e.g., from the image repository 120) may be stored. Each compute node 131 may also include an agent 230 which may communicate with the corresponding local image repository 240 in order to maintain a table 260 of all of the layers (e.g., base layers) that are stored on the compute node 131, as discussed further with respect to FIG. 2B. The control plane 215 may include a master agent 250 which may communicate with the respective agent 230 of each compute node 131 in order to obtain that compute node 131's table 260 and gain insight as to the distribution and availability of layers among the compute nodes 131. Stated differently, the master agent 250 may communicate with the respective agent 230 of each compute node 131 to determine a set of different layers that are locally available on that worker node 131. The master agent 250 may maintain a master table 250A that indicates the set of different layers available on each of the compute nodes 131.

FIG. 2C illustrates an agent 230A determining the set of different layers that is locally available (i.e., stored locally) on compute node 131A. The agent 230A may communicate with the local image repository 240A to determine the different image files that are locally available to the compute node 131A. In the example of FIG. 2C, the agent 230A may determine that image files 241 and 242 are locally available to the compute node 131A. The agent 230A may then decompose each of the image files 241 and 242 to determine the layers they are comprised of, and determine that image file 241 comprises layers 201 and 202 and that image file 242 comprises layers 201 and 203. Each of the layers 201 and 202 may have an associated hash and the agent 230A may determine the number of unique hashes in order to determine the number of different layers that are locally available to the compute node 131A. In the example of FIG. 2C, the hash for layers 202 and 203 may each show up once, while the hash for layer 201 may show up twice. Thus, the agent 230A may determine that there are three unique hashes, corresponding to layers 201, 202, and 203 respectively. The agent 230A may update table 260A to indicate that layers 201, 202, and 203 are locally available to the compute node 131A.

As the compute node 131A imports additional image files or layers, or deletes certain image files or layers, the agent 230A may perform the process described above with respect to FIG. 2B (e.g., at regular intervals or in response to import or deletion of image files or layers) in order to determine the layers that are currently locally available to the compute node 131A and update the table 260A.

At block 410, in response to receiving a request to deploy a container 280, the computing device 110 (via the master agent 250) may decompose a specification file 285 of the container 280 to determine a set of required layers of the container 280. More specifically, (referring back to FIGS. 2A and 2B) the master agent 250 may monitor the container host 214's deployment queue and when a new container 280 is queued for deployment into the environment, the master agent 250 may request the container 280's specification file 285. The master agent 250 may decompose the container 280's specification file 285 into layers required for execution of the container 280 and at block 415 may cross reference (i.e., compare) the layers required for execution of the container 280 with the set of different layers that is locally available on each compute node 131 (included within table 250A) in order to identify a number layers required for execution of the container (i.e., layers that appear within the specification file 285 of the container) that is locally available on each of the compute nodes 131. At block 420, the master agent 250 may determine the appropriate compute node 131 on which to deploy the container based on the number layers required for execution of the container that is locally available on each of the compute nodes 131 as well as on the available resources of each compute node 131. In some embodiments, the master agent 250 may determine which compute nodes 131 have the most layers required for execution of the container (e.g., the top 3, 5 or any other appropriate number), and consider only those compute nodes 131 when making scheduling decisions about the container to an appropriate node 131. The available resources of each compute node 131 may include the available network bandwidth, the available central processing unit (CPU) resources, and the available memory resources (e.g., available storage), among others.

The goal of the master agent 250 is to find a compute node 131 where deploying the container will minimize the footprint impact with respect to network overhead, CPU availability, and available storage. Thus, the master agent 250 may balance the number of layers that potential compute nodes 131 may have to pull (e.g., from image repository 120) to obtain all of the layers required for execution of the container with the available CPU/storage resources to accommodate the additional layers pulled when determining a compute node 131 to assign the container to. Upon determining the compute node 131 that the container should be assigned to, the master agent 250 may instruct the control plane 215 to send the container to the determined compute node 131.

As the architecture of the system 100 increases in size, the advantages of the embodiments of the present disclosure increase as well since many image files can comprise hundreds of layers, many of which are statistically likely to already be present in unrelated images that are currently stored on compute nodes 131. This provides a large benefit in terms of resource conservation compared to current solutions to container scheduling and has the added benefit of speeding up the bring-up time of a container by virtue of utilizing a larger number of locally stored layers.

In some embodiments, the master agent 250 may perform a load balancing function that includes monitoring the cluster of compute nodes 131 to determine whether/when a container should be migrated from one compute node 131 to another and intelligently determining which compute node 131 the container should be migrated to. Referring back to FIG. 2A, upon determining that the particular container (not shown) executing on compute node 131A needs to be migrated, the master agent 250 may decompose the particular container's specification file (not shown) into the layers required for execution of the particular container and cross reference the layers required for execution of the particular container with the table 250A in order to identify a number layers required for execution of the particular container (i.e., layers that appear within the specification file of the particular container) that is locally available on each of the compute nodes 131. As discussed hereinabove, each agent 230 may perform the process described above with respect to FIG. 2B at regular intervals or on any other appropriate basis, thus allowing the master agent 250 to keep the table 250A up to date (e.g., by communicating with each agent 230 on any appropriate basis). The master agent 250 may determine the appropriate compute node 131 to which the particular container should be migrated based on a number layers required for execution of the particular container that is locally available on each of the compute nodes 131 as well as on the available resources of each compute node 131.

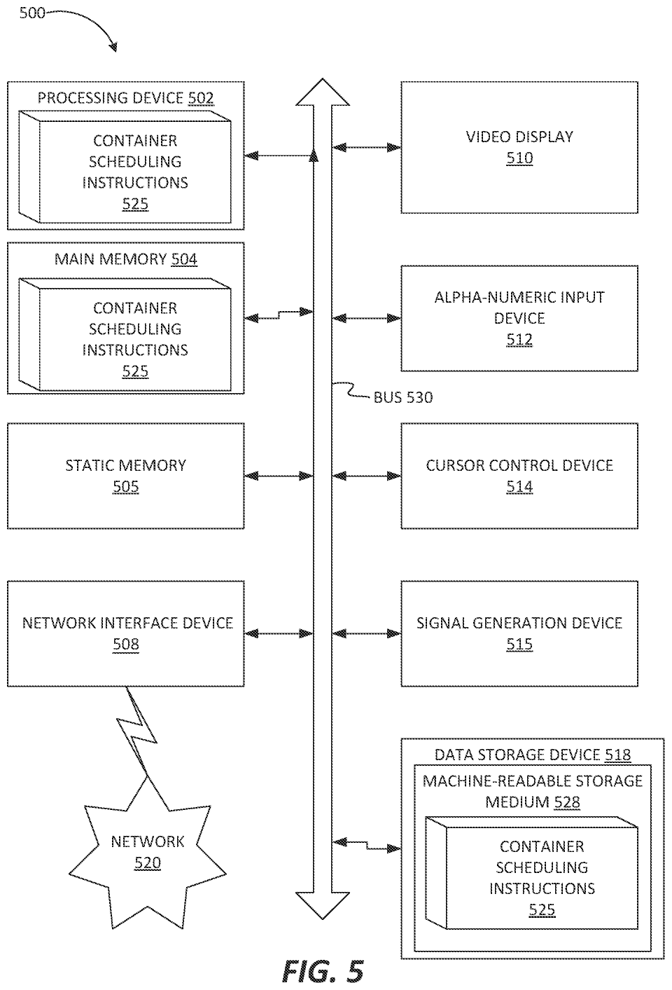

FIG. 5 illustrates a diagrammatic representation of a machine in the example form of a computer system 500 within which a set of instructions, for causing the machine to perform any one or more of the methodologies discussed herein for intelligently scheduling containers.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute container scheduling instructions 525, for performing the operations and steps discussed herein.

The data storage device 518 may include a machine-readable storage medium 528, on which is stored one or more sets of container scheduling instructions 525 (e.g., software) embodying any one or more of the methodologies of functions described herein. The container scheduling instructions 525 may also reside, completely or at least partially, within the main memory 504 or within the processing device 502 during execution thereof by the computer system 500; the main memory 504 and the processing device 502 also constituting machine-readable storage media. The container scheduling instructions 525 may further be transmitted or received over a network 520 via the network interface device 508.

The machine-readable storage medium 528 may also be used to store instructions to perform a method for intelligently scheduling containers, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
determining a set of different layers that is locally available on each of a set of compute nodes;
in response to receiving a request to deploy a container, decomposing a specification file of the container to determine a set of required layers of the container;
comparing, by a processing device, the set of required layers to the set of different layers that is locally available on each of the set of compute nodes to determine a number of the set of required layers that is locally available on each of the set of compute nodes; and
assigning the container to a compute node of the set of compute nodes based at least in part on the number of the set of required layers that is locally available on each of the set of compute nodes.

2. The method of claim 1, wherein determining the number of different layers that are locally available on a particular compute node of the set of compute nodes comprises:
communicating, via an agent executing on the particular compute node, with a local image repository of the particular compute node to determine which image files are stored on the particular compute node;
analyzing layers that each of the image files stored on the particular compute node are comprised of to determine the number of different layers that are locally available on the particular compute node; and
generating a table indicating the number of different layers that are locally available on the particular compute node.

3. The method of claim 1, wherein the container is assigned to a compute node of the set of compute nodes based further on resource availability information of each of the set of compute nodes.

4. The method of claim 3, wherein the resource availability information of a particular compute node comprises: a network bandwidth of the particular compute node, a central processing unit (CPU) availability of the particular compute node, and a memory availability of the particular compute node.

5. The method of claim 1, further comprising:
generating a master table indicating the set of different layers that is locally available on each of the set of compute nodes.

6. The method of claim 5, wherein comparing the set of required layers to the set of different layers that is locally available on each of the set of compute nodes comprises comparing the set of required layers to the master table.

7. The method of claim 1, further comprising:
in response to receiving a request to migrate a particular container from a first compute node of the set of compute nodes, comparing a set of required layers of the particular container to the set of different layers that is locally available on each of the set of compute nodes to determine a number of the set of required layers of the particular container that is locally available on each of the set of compute nodes; and
migrating the particular container to a second compute node of the set of compute nodes based at least in part on the number of the set of required layers of the particular container that is locally available on each of the set of compute nodes.

8. A system comprising:
a memory; and
a processing device operatively coupled to the memory, the processing device to:
determine a set of different layers that is locally available on each of a set of compute nodes;
in response to receiving a request to deploy a container, decompose a specification file of the container to determine a set of required layers of the container;
compare the set of required layers to the set of different layers that is locally available on each of the set of compute nodes to determine a number of the set of required layers that is locally available on each of the set of compute nodes; and
assign the container to a compute node of the set of compute nodes based at least in part on the number of the set of required layers that is locally available on each of the set of compute nodes.

9. The system of claim 8, wherein to determine the number of different layers that are locally available on a particular compute node of the set of compute nodes, the processing device is to:
communicate, via an agent executing on the particular compute node, with a local image repository of the particular compute node to determine which image files are stored on the particular compute node;
analyze layers that each of the image files stored on the particular compute node are comprised of to determine the number of different layers that are locally available on the particular compute node; and
generate a table indicating the number of different layers that are locally available on the particular compute node.

10. The system of claim 8, wherein the container is assigned to a compute node of the set of compute nodes based further on resource availability information of each of the set of compute nodes.

11. The system of claim 10, wherein the resource availability information of a particular compute node comprises: a network bandwidth of the particular compute node, a central processing unit (CPU) availability of the particular compute node, and a memory availability of the particular compute node.

12. The system of claim 8, wherein the processing device is further to:
generate a master table indicating the set of different layers that is locally available on each of the set of compute nodes.

13. The system of claim 12, wherein to compare the set of required layers to the set of different layers that is locally available on each of the set of compute nodes, the processing device is to compare the set of required layers to the master table.

14. The system of claim 8, wherein the processing device is further to:
in response to receiving a request to migrate a particular container from a first compute node of the set of compute nodes, compare a set of required layers of the particular container to the set of different layers that is locally available on each of the set of compute nodes to determine a number of the set of required layers of the particular container that is locally available on each of the set of compute nodes; and
migrate the particular container to a second compute node of the set of compute nodes based at least in part on the number of the set of required layers of the particular container that is locally available on each of the set of compute nodes.

15. A non-transitory computer-readable medium having instructions stored thereon which, when executed by a processing device, cause the processing device to:
determine a set of different layers that is locally available on each of a set of compute nodes;
in response to receiving a request to deploy a container, decompose a specification file of the container to determine a set of required layers of the container;
compare, by the processing device, the set of required layers to the set of different layers that is locally available on each of the set of compute nodes to determine a number of the set of required layers that is locally available on each of the set of compute nodes; and
assign the container to a compute node of the set of compute nodes based at least in part on the number of the set of required layers that is locally available on each of the set of compute nodes.

16. The non-transitory computer-readable medium of claim 15, wherein to determine the number of different layers that are locally available on a particular compute node of the set of compute nodes, the processing device is to:
communicate, via an agent executing on the particular compute node, with a local image repository of the particular compute node to determine which image files are stored on the particular compute node;
analyze layers that each of the image files stored on the particular compute node are comprised of to determine the number of different layers that are locally available on the particular compute node; and
generate a table indicating the number of different layers that are locally available on the particular compute node.

17. The non-transitory computer-readable medium of claim 15, wherein the container is assigned to a compute node of the set of compute nodes based further on resource availability information of each of the set of compute nodes.

18. The non-transitory computer-readable medium of claim 17, wherein the resource availability information of a particular compute node comprises: a network bandwidth of the particular compute node, a central processing unit (CPU) availability of the particular compute node, and a memory availability of the particular compute node.

19. The non-transitory computer-readable medium of claim 15, wherein the processing device is further to:
generate a master table indicating the set of different layers that is locally available on each of the set of compute nodes.

20. The non-transitory computer-readable medium of claim 19, wherein to compare the set of required layers to the set of different layers that is locally available on each of the set of compute nodes, the processing device is to compare the set of required layers to the master table.
